(19) United States
(12) Patent Application Publication
(10) Pub. No.: US 2015/0193566 A1
(43) Pub. Date: Jul. 9, 2015

(54) CAPACITY PLANNING SYSTEM

(71) Applicants: Jerome Rolia, Kanata (CA); James Pruyne, Naperville, IL (US); Sharad Singhal, Belmont, CA (US)

(72) Inventors: Jerome Rolia, Kanata (CA); James Pruyne, Naperville, IL (US); Sharad Singhal, Belmont, CA (US)

(21) Appl. No.: 14/410,005

(22) PCT Filed: Jun. 29, 2012
(86) PCT No.: PCT/US2012/045063

§ 371 Date: Dec. 19, 2014

(51) Int. Cl. G06F 17/50; G06N 5/02

(52) U.S. Cl. CPC G06F 17/5009; G06N 5/02

(57) ABSTRACT

A capacity planning system (100, 200), comprising a memory device (112, 212) storing a number of historical input data files (115, 215), a number of input data configuration files (120, 220), and a number of simulator configuration files (125, 225), a processor (130, 230) communicatively coupled to the memory device (112, 212), a decision policy module (110, 210) communicatively coupled to the processor (130, 230) that creates a number of decision policies based on an environment in which the system (100, 200) is operating and the historical input data files (115, 215), and a simulator (135, 235) that executes the number of decision policies based on the data provided to it by the processor (130, 230) and provides a dynamically evolving model of an environment as a number of resources defined in the number of simulator configuration files (125, 225) move through the environment.

### BACKGROUND

Service environments are complex environments where resources including staff and equipment both provide and demand services while serving customers. Competition for these resources among a number of processes being executed in parallel adds to the complexity of the environment. While traditional simulation modeling methods are used to study these environments today, they are inflexible for a number of reasons. Often the traditional simulation modeling implements a static model where changes to customer care processes require changes to the model as a whole. Additionally, there are many different types of customer care processes and many differences between instances of care processes in various types of environments. Reducing these processes to an abstracted process model may not be representative of real life events and especially events that may constantly change. Furthermore, it can be difficult to know which resources in the environment matter most to the effect flow of the environment. Sometimes resources that are lightly utilized on average can have significantly negative consequences on performance of the service environment as a whole.

### BRIEF DESCRIPTION OF THE DRAWINGS

The accompanying drawings illustrate various examples of the principles described herein and are a part of the specification. The examples do not limit the scope of the claims.

FIG. 1 is a block diagram showing a capacity planning system according to one example of principles described herein.

FIG. 2 is a block diagram showing a capacity planning system according to another example of principles described herein.

FIG. 3 is a diagram of a historical trace used in the system of FIG. 1 according to one example of principles described herein.

FIGS. 4A and 4B are tables showing statistical results of the implementation of the system of FIG. 1 according to one example of principles described herein.

FIG. 5 is a flowchart showing a method of building a dynamic simulation model according to one example of principles described herein.

Throughout the drawings, identical reference numbers designate similar, but not necessarily identical, elements.

### DETAILED DESCRIPTION

The present specification describes a capacity planning system (100, 200), comprising a memory device (112, 212) storing a number of historical input data files (115, 215), a number of input data configuration files (120, 220), and a number of simulator configuration files (125, 225), a processor (130, 230) communicatively coupled to the memory device (112, 212), a decision policy module (110, 210) communicatively coupled to the processor (130, 230) that creates a number of decision policies based on an environment in which the system (100, 200) is operating and the historical input data files (115, 215), and a simulator (135, 235) that executes the number of decision policies based on the data provided to it by the processor (130, 230) and provides a dynamically evolving model of an environment as a number of resources defined in the number of simulator configuration files (125, 225) move through the environment.

The present specification further describes a method (500) of building a dynamically evolving model within a capacity planning system, comprising defining (505) resources available in an environment, defining (510), with a decision policy module (110, 210), a number of policies to be implemented in the environment, receiving (515) historical traces of monitoring data, and with a processor (130, 230), creating (520) a dynamic model of the environment based on the historical traces of monitoring data.

As described above, many service environments rely on the proper implementation of resources in an efficient manner so as to achieve the best performance results. Often any number of staff members may be competing for any number of resources while each staff member is implementing various kinds of services or processes.

For example, hospitals may provide any number of services to a number of customers simultaneously. These hospitals employ resources that include staff, rooms, and equipment for patient care. Administrators from different departments or groups within the hospital are tasked to decide staffing levels, equipment levels, room usage, and patient care priorities. Members of the staff may make decisions regarding which patient receives medical care next as well as the order in which patients receive that care. As the flow of patients moves through the hospital, resources may be removed from a service, added to a service, or taken out of service for maintenance. Additionally, each staff member may be made unavailable at various stages of the flow for a number of reasons such as breaks and conflicting schedules. The decisions on who and what to employ so as to efficiently service each patient affects the outcome or performance of the hospital in general. Performance indicators may be calculated at the end of the processes associated with each patient. These performance indicators may show, for example, the length of a stay in the hospital an average patient may experience, how satisfied a patient was with the care and service provided to them, and the productivity of each staff member and/or other resource. A low performance indicator may prompt an administrator to adjust the amount of staff or other resources as well as find other ways along the process flow to increase the speed and efficiency in which any given patient is cared for.

For purposes of simplicity in explanation, the present system and method is discussed in terms of a health care providing facility such as a hospital. However, the present system and method may be implemented in various other types of service environments.

To this end, in the present specification and in the appended claims, the term “service environment” is meant to be understood broadly as any environment in which a number of processes are executed in parallel. In one example, the processes are executed using a set and predetermined amount of resources. In another example, the processes are executed with an ever changing amount of resources made available. Some examples of service environments may include hospital environments, hospice environments, restaurants, banks, departments of motor vehicles, retail sales services, information technology services, and vehicle service facilities, among others.

Moreover, in the present specification and in the appended claims, the term “process execution” is meant to be understood broadly as any environment in which a number of processes are executed in parallel by a person, a number of people, or a group of people or, similarly, other systems, organizations, and entities.

Additionally, in the present specification and in the appended claims, the term “performance indicator” is meant to be understood broadly as any performance measurement within a service environment. In one example, a performance indicator may be used to measure the success of an implementation of a certain rule or set of constraints.

Further, in the present specification and in the appended claims, the term “customer” is meant to be understood broadly as any person or entity that may receive a service from the service environment. In one example below, a customer may be a patient at a hospital.

Even further, in the present specification and in the appended claims, the term “resource” is meant to be understood broadly as any person or object which exists or could exist in the environment and which could be used to provide a service to a customer. In one example a resource may be a person acting as an employee working in the environment. In another example, a resource may be a physical tool used to provide a service to a customer.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

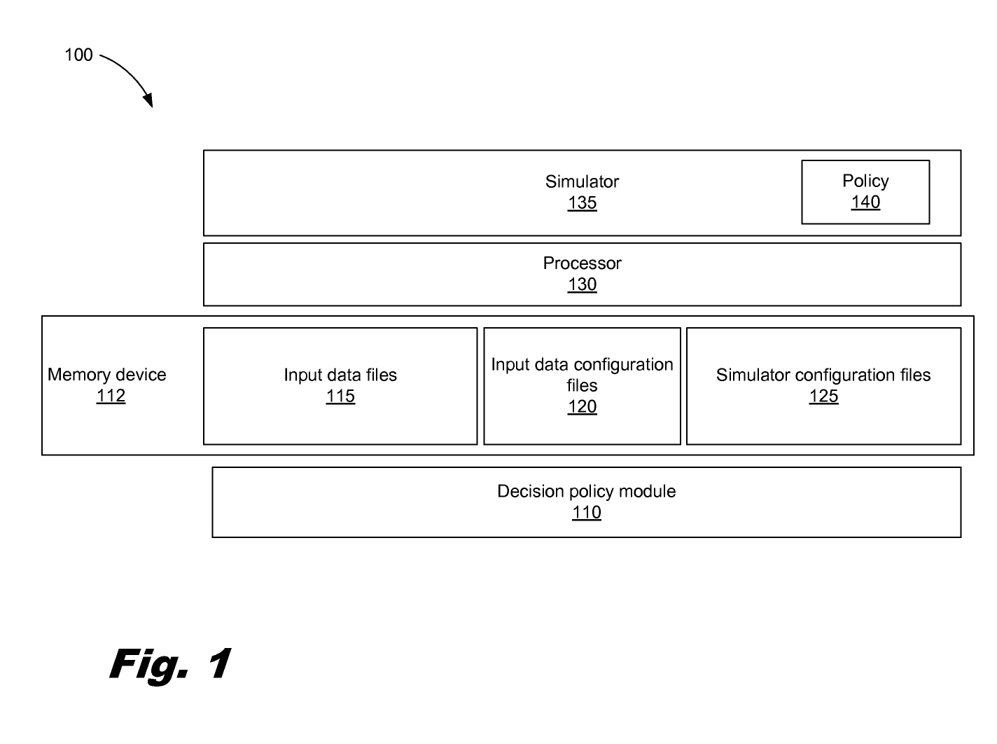

FIG. 1 is a block diagram showing a capacity planning system (100) according to one example of principles described herein. The capacity planning system (100) may be associated with a computing device in a number of various configurations. In one example, the capacity planning system (100) may be implemented on a computing device within a network in a healthcare facility such as a hospital. However, the system (100) described herein may be deployed or used in any environment where multiple processes are being run using limited or changing resources. The capacity planning system (100) may also be used in an environment that is distinct from the source of input files (115) and may be used in a manner that is or is not acting in real-time with the healthcare facility. Therefore, although the present disclosure describes the module in the context of being implemented in a hospital setting, this is not intended to be limiting and is set herein as an example of the use and implementation of the capacity planning system (100).

Additionally, although FIG. 1 shows the capacity planning system (100) as a single unit, various elements, modules, or sub-modules of the capacity planning system (100) may be separated into multiple parts. For example, some elements of the system (100) may be implemented on a desktop computer within the service environment while the other modules are communicatively coupled to the desktop computer via a network connection. In this example, the other modules may be accessible via the computing device implementing a browser application. Still further, in other examples, the system components and operations may be implemented at other physical locations. These other components and operations may be communicatively coupled to the environment on which the system (100) is to run.

The capacity planning system (100) may comprise a decision policy module (110); a memory device (112) to store input data files (115), input data configuration files (120), and simulator configuration files (125); a processor (130); and a simulator (135) enacting policy (140).

The decision policy module (110) guides the behavior of the simulator (135) by determining which process being executed in the service environment has priority. The decision policy module (110) may therefore create a number of policies which state that certain processes are to be executed before others, provide that the more expensive resource be used the most often, or provide that certain employees or service providers perform certain tasks based on their experience level, to name a few. The decision policy module (110) may upload the created policies (140) to the simulator (135) so that the simulator (135) may match certain resources and people with a service that is to be provided to a customer.

In the context of a health care environment, the decision policy module (110) may comprise a number of policies that execute more urgent health care procedures before other less urgent procedures. An example policy may also define which equipment or resource is to be used the most often and may depend upon a number of factors such as the cost of the machine, the length of time that has elapsed since the particular piece of equipment had been serviced, or which health care procedure may better benefit from the use of the resource. Still further a policy may define that a specific health care employee should be used instead of another based upon the amount of overtime one particular employee has accumulated.

The memory device (112) may be any volatile or non-volatile memory device. Some examples of a memory device (112) may include a memristive device, a hard disk drive (HDD), a random-access memory (RAM) device, a read-only memory (ROM) device, and a flash memory device, among others. The memory device (112) may be used to store the input data files (115), input data configuration files (120), and simulator configuration files (125) for use by the system (100).

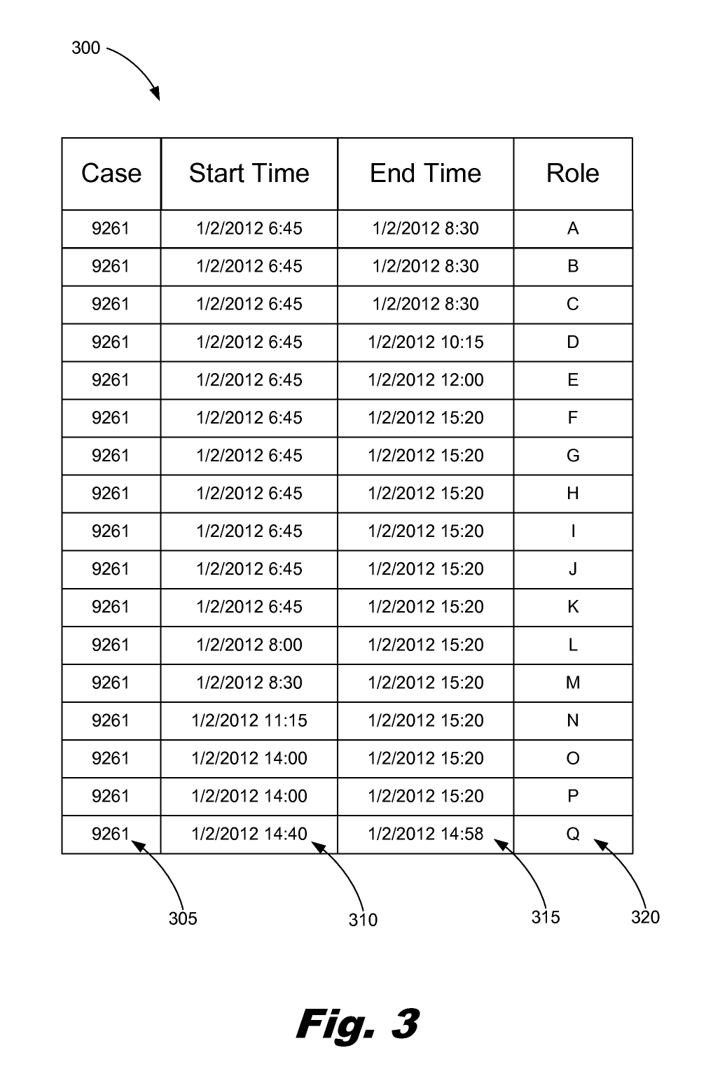

The input data files (115) may comprise a number of data files describing, similar to the historical trace (300) shown in FIG. 3, specific instances of services to customers or processes being executed in the environment. In the hospital scenario, the input data files may be files from the hospital that the system (100) is currently being implemented at as well as other hospitals. These input data files (115) may not, however, include all or similar types of data. In one example, the data may describe the customer as a “customer” while the system (100) is to receive data describing a “patient.” In this case, the format of the input data files (115) may be dissimilar to that in which the system (100) may be able to use it. In order to rectify this, the input configuration files (120) allow the appropriate data to be mapped in such a way to be correctly interpreted by the system (100). Consequently, where the input data files (115) contain information about a “customer,” the processor (130) uses the input data configuration files (120) to change the description of that “customer” data to “patient” so that the system (100) may properly interpret and use that data. This allows the system (100) to accept different types of data from different systems and use that data in a helpful way to drive the simulator. Additionally, because the simulator (135) may read multiple instances of the data at one given time, multiple schemas from the monitoring model schema module (205) may be used simultaneously to drive the simulator (135). The input data configuration files (120) then speed up the normalization of the input data files (115) so that the simulator (135) can run the simulation.

The simulator configuration files (125) may include files which describe the resources and people available to provide a service to a customer at any one given period of time during the day. Additionally, the simulator configuration files (125) may describe the abilities of the various resources and people available to the system (100). For example, in a hospital environment, the simulator configuration files (125) may describe the number of rooms available to a patient. The number of rooms may not change because of the nature of the physical location. However, the simulator configuration files may further include the number of beds available to a patient in each of the rooms. This latter configuration file may change from time to time, and the system (100) may allow a user to change that parameter when it does change. Still further, the simulator configuration files (125) may include a description of the employees within the hospital from the janitors all the way up to surgeons. Each file describing a person may further define his or her working schedule as well as their role within the environment. Additional descriptions may include any specific abilities which may be used in the environment including any special skills a specific person may have. The simulator configuration files (125) may therefore allow the simulator (135) to search through the simulator configuration files (125) to determine if any employee speaks a foreign language, can operate on a heart, has specific anesthetic skills, etc. Depending on the availability of the user, the simulator (135) may then be able to decide using the simulator configuration files (125) whether or not to use that person.

The processor (130) is a configuration driven input processor that reads all the information provided in the input data files (115), input data configuration files (120), and simulator configuration files (125) and understands how to build the data structures as well as the state of information to be input into the simulator (135). The processor (130) therefore maps the information provided by the input data files (115), input data configuration files (120), and simulator configuration files (125) and presents it to the simulator (135) in a form such that the simulator (135) can compute that information.

The simulator (135), after receiving the processed data from the processor (130), begins to match certain service requests within the environment with resources and people which can meet those needs. In one example, the simulator (135) may match the defined resources to the service requests in real time. Again, in the hospital environment, the simulator (135) may determine that a certain service such as dialysis may need to be performed on a patient. This simulator (135) may understand from the data provided to it that a blood dialysis procedure requires a certain type of nurse as well as a dialysis machine. The simulator (135) then, in a tuple space-type fashion, sets up a request for that nurse and a dialysis machine. Specifically, the simulator (135) may use a shared bus wherein a request for services is matched up with the resources that are available. Consequently, the simulator (135) may receive the requests for resources and match those requests with resources that are available. Similarly, the resources that are made available may be matched up with a request for a service as those requests come into the system (100). The matching process may take into account the roles, e.g., a machine able to perform dialysis or nurse that is able to operate a dialysis machine, and capacities of each resource and the similarly defined roles and capacities required by requests for resources. Continuing with the example above, the simulator (135) may look to see if both a nurse and a dialysis machine are available for the procedure. When these two resources become available, the simulator (135) matches those resources to the procedure or service requested.

The simulator (135) may further keep track of how long the process may take thereby defining how long the nurse and dialysis machine will be unavailable for other procedures and may use this information for advance resource reservations. Therefore, the simulator (135) creates a dynamic model of every resource, employee, and patient that moves through the environment monitored by the system (100). Thus, the simulation model structure is not static. It evolves dynamically according to inputs (115, 120, 125, 215, 220, 225).

The policy (140) may define the current policy being executed on the simulator (135) which, along with the data provided to it by the processor (130), drives the dynamic model. If a resource is matched with more than one service request, the policy (140) determines which service request shall use the resource so that the resource can be marked as unavailable or reserved. In one example, the policy (140) may include all decision policies defined in the decision policy module (110). In other examples, the policy (140) may include a sub-set of decision policies defined in the decision policy module (110). In yet another example, a user of the system (100) may turn off or on specific decision policies in real time as a method of adjusting the dynamic model. For example, in the hospital scenario the user, upon seeing a relatively larger amount of patients come into the hospital seeking medical attention, he or she may cause the simulator (135) to disregard the policy (140) which defines whether or not an employee can or cannot work based on that employee's overtime accumulation status.

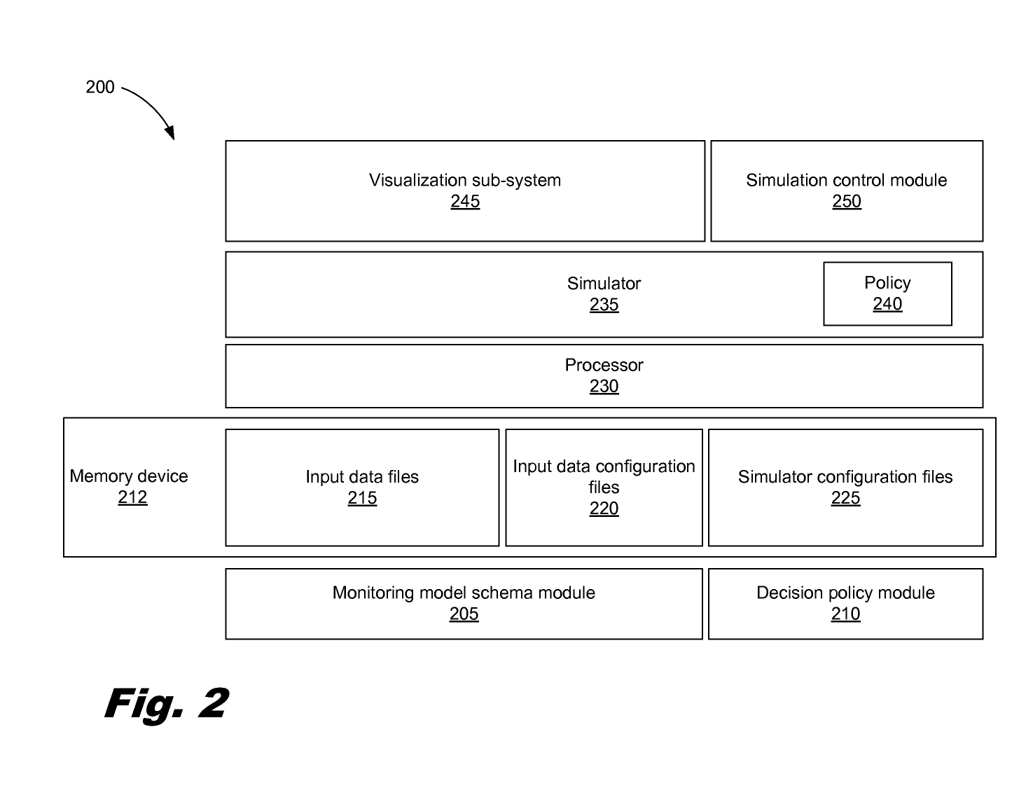

FIG. 2 is a block diagram showing a capacity planning system (200) according to another example of principles described herein. The system (200) may include similar elements (210-240) as that shown in FIG. 1 with the addition of a monitoring model schema module (205), a visualization sub-system (245), and a simulation control module (250).

The monitoring model schema module (205) provides monitoring data that is environment specific to the simulator (235). The monitoring model schema module (205) defines the attributes of the data that are used as input into the system (100, 200). Additionally, the monitoring model schema module (205) defines the types and form of data that may be received by the system (100, 200) in order to simulate the service environment. The data may describe process and monitor people, places, and things in the environment.

In one example, the data may come in the form of historical traces (300) which describe real or synthetically prepared processes. In the example of a hospital environment, each process described in the historical traces (300) may have a sequence of a number of actions which indicate that a service is being provided or that a service is needed to complete the service. The processes and the corresponding actions describe the competition for resources over the environment.

An example of a historical trace (300) is shown in FIG. 3. In this example, the historical trace (300) defines a case number (305) in a health care facility. Every action associated with that case number is listed. The case number (305) may be a number associated with a person or resource. In the example shown in FIG. 3, the case number (305) is “9261” and may be associated with a customer or patient within a hospital service environment. The historical trace (300) may further include a start time (310) and end time (315) indicative of when a particular service had started and ended for that customer. Still further the historical trace (300) may include a role code (320) which defines which person or resource was involved in the service. For example, the role code (320) may indicate that a certain person had provided a service to a customer between the indicated start (310) and end times (315). In another example, the role code (320) may indicate that a certain resource was used to service the customer. In a health care scenario, the role code (320) may be indicative of a device being used such as an x-ray. In yet another example, the role code (320) may indicate that both a specific type of person and resource was used in providing a service to the identified customer.

Returning to FIG. 2, the monitoring model schema module (205) maps the historical traces onto a simulation model and allows users to control the generation of the dynamically evolving model to evaluate different planning issues. In one example, the mapping may be completed in two stages. First, monitoring model schema is defined in a tabular structure that is defined in an input configuration file (220). The input data configuration file (220) identifies each field in the input data files (215) along with metadata such as whether an attribute is a key value. In one embodiment, this information is used to create intermediate Java classes that describe the people, places and things and the relationship among them. Similarly, a simulator configuration file (225) is used to map these intermediate classes onto Java classes in a form that can be used by the simulator (235).

The visualization sub-system (245) may be a graphical user interface which may show a user of the system (200) the movement of resources, people, and customers through the environment in real time. Therefore, a user of the system (200) may, in a hospital environment, be able to see which rooms in the hospital are occupied, where specific employees are located, what the employees are doing, which resources are currently available or not, and reservations for resources. The simulation control module (250) may allow the user of the system (200) to view specific departments or sub-sections of the physical environment the system (200) is implemented on. In one example, a white list/black list scheme may employ regular expressions to specify what roles to include in the simulation and which to exclude. For example, a user may wish to focus on one or two departments within a hospital. Demands upon excluded roles are still represented but do not incur queuing delays. This controls the abstraction and hence planning issue being considered without requiring a model builder to create a new model for that additional purpose. This enables more exploration by a user regarding performance oriented situational awareness. When the user views multiple departments, he or she may be able to adjust parameters and policies in the system in real time to both see the effect that change may have as well as implement a test policy to see how it may affect the dynamic model over time.

The visualization sub-system (245) and simulation control module (250) may further allow a user to determine if there exists a sufficient number of resources in the environment to properly service the customers. The user may note that if a specific department were to have a larger or smaller number of resources that department may provide a better or relatively quicker service to any given customer. Upon this realization, the user may assign more resources or alter the distribution of resources in the decision policy such that specific service goals are better met.

The system (200) may further allow a user to interrupt the simulator (235) when a decision is being made such that a different decision is forced on the simulator possibly contrary to a decision policy defined by the decision policy module (210). This may allow a user to quickly change the dynamic model based on further information provided to the user but not to the system (200). For example, when a patient is admitted to a hospital, a triage nurse may have indicated that the patient's injuries or ailments were worse than what they really were. As a result, the simulator (235) may have assigned certain resources and employees to this patient when that may not have been necessary. The user of the system (200) may then interrupt the simulator (235) and assign different resources to the patient or change certain data associated with the patient in order to better reflect the real situation.

The system (100, 200) therefore causes the simulator (135, 235) to create the dynamic model using the data (115, 120, 125, 215, 220, 225) and policies (110, 140, 210, 240) predefined by the user. The visualization sub-system (245) and simulation control module (250) may allow a user to view and change certain aspects of the data (115, 120, 125, 215, 220, 225) and policies (110, 140, 210, 240) in real time so as to create a more streamlined and efficient dynamic model. This allows a user to make better decisions that may be contrary to the policy. Still further, the system (100, 200) may alert the user when a decision is to be made which cannot be made based on the policy. This alert may ask the user to make a decision which may not be definable as a policy. The user may then select the proper decision and the simulator (135, 235) may implement that decision. The alerts may further allow a user to create a decision policy so that similar alerts will not be displayed again.

The system (100, 200) may further receive input from other systems which may help a user create a certain policy. The created policy may then be encoded to the decision policy module (110, 210). This allows a user to explore whether or not the new policy will be beneficial to the dynamic model. In one example, the user may see a non-real life simulation before implementation of the real life simulation is initiated using the new policy.

Additionally, the system (100, 200) may be used to create experimental designs without implementing the system in a real-time, real life scenario. The system (100, 200) may therefore be used to help create the physical space of an environment before that physical space is built. This way, a higher level of optimization of an example environment may be achieved even before the system (100, 200) is used in that environment.

Even further, the user may use the visualization sub-system (245) to determine which decisions may be made next. In one example, a number of decisions may be anticipated by the simulator (235) in which the decisions have been defined as being important enough to require a human to choose which decisions to make. The decisions may be presented to the user based on anticipated services that will need to be provided or resources which may become available shortly. The user may then cause the simulator (235) to simulate forward in time what would happen if a particular decision was made. This way, the user may determine which of the number of decisions would best benefit the dynamic model. The simulator (235) may therefore be used to anticipate the ramifications of certain decisions.

The system (100, 200) may also support a Monte Carlo simulation process in which randomness may be introduced into the system (100, 200) where a predefined number of parallel process are running with a predefined set of resources are assumed to exist. In this case, the system (100, 200) may provide statistics on possible outcomes based upon that randomness occurring. Multiple passes over the data (115, 120, 125, 215, 220, 225) and the use of the randomness enable the system (100, 200) to report a range of possible impacts on the performance of the system in response to changes to the mix or arrival rate of processes, resource levels, and decision making policies. In the health care scenario, the system (100, 200) may understand, for example, that it should take a certain number of minutes to treat a patient in the triage center with a variation of a few minutes. In implementing a Monte Carlo simulation process, the system (100, 200) may run the simulation a relatively large number of times and provide results that show how effective a certain policy decision is being implemented on the system (100, 200). With this knowledge, a user may adjust the policy in order to lower the risk of there being a catastrophe occurring.

Using the above system (100, 200) and method the advantages of the system have been demonstrated using one week's worth of monitoring data from operating rooms within a hospital. The examples demonstrate the ability to simulate a diverse mix of complex healthcare processes using the method as well as the ability to re-configure the planning issue being considered by the user of the system. FIG. 3 shows an example of monitoring data from the hospital. Specifically, the data describes a surgical procedure conducted during that week. The data shows that an operating room is to be occupied from 6:45 am through to 14:58 pm. In the simulation, the procedure may have a different start time but the other details regarding roles and the durations of their services remain the same. For example, a number of staff members participate in the procedure. These staff members are indicated with 15 different roles labeled A. through Q. Some of the roles that start at 6:45 am have different ending times and consequently different resource demands. Other roles start part way through the procedure, e.g., roles L.-Q. Simulated staff members have processes that make them available to support the roles they are trained for. In the simulation, the resources that support the roles are reserved before the procedure can begin so that there are no unintended queuing delays during the procedure. Resources can have many pending but non-overlapping reservations. Processes can have one or more procedures. The dynamic simulation method supports a variety of blocking and non-blocking relationships.

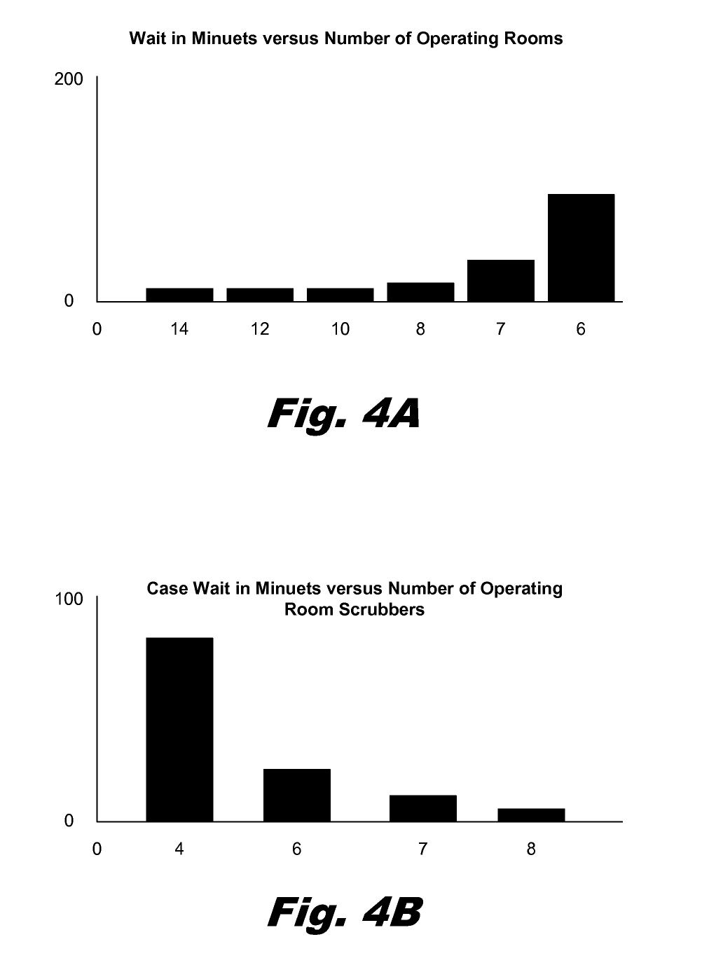

FIGS. 4a and 4b show the results of the analysis with a fixed number of surgeons and anesthetists. The number of operating rooms is varied for planning purposes. FIG. 4A shows that at least 8 operating rooms keep the average patient waiting time below 10 minutes. Using more than 8 rooms does not significantly reduce patient waiting times. By varying the duration of procedures, in a representative manner, and by repeating the simulation, a distribution for the waiting time performance goal can be reported for each number of operating rooms.

FIG. 4B shows results for the same model with 14 operating rooms but also adds in the role of scrubbers. Using 6 scrubbers has an average wait time of 16 minutes, using 7 scrubbers has an average wait time of 6 minutes. The system (100, 200), therefore, controls the planning model simply by indicating which roles to include and exclude.

An automated sensitivity analysis may automatically perturb the dynamic model to determine which resources, as they appear in the input data files (115, 215), affect measures of system performance most. The analysis can include one resource after another in the model and adjust its number of resources available. An impact of these adjustments may then be compared to see if any of the adjustments significantly affects system performance. Any adjustments that significantly affects the system performance may be reported to the user or automatically included in the dynamic model based on the preference of the user.

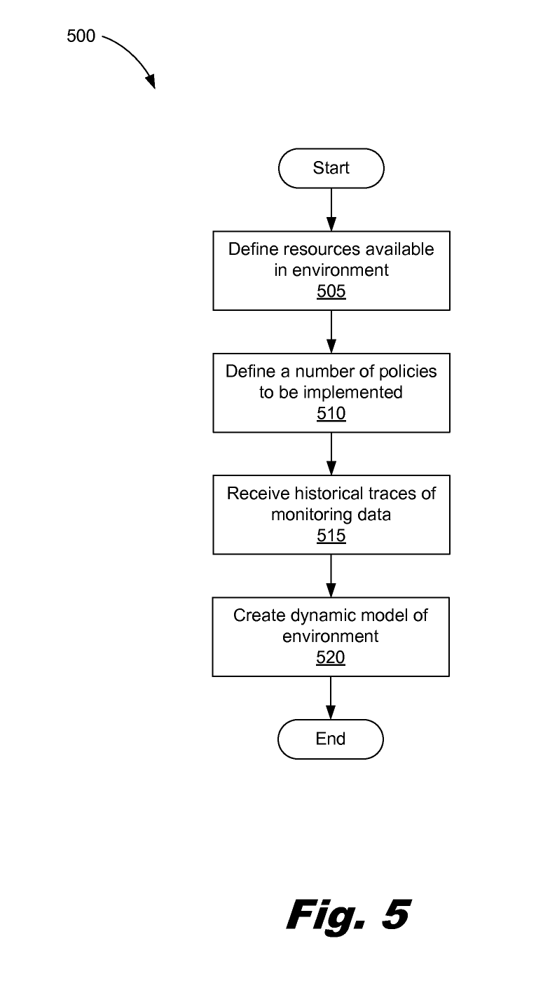

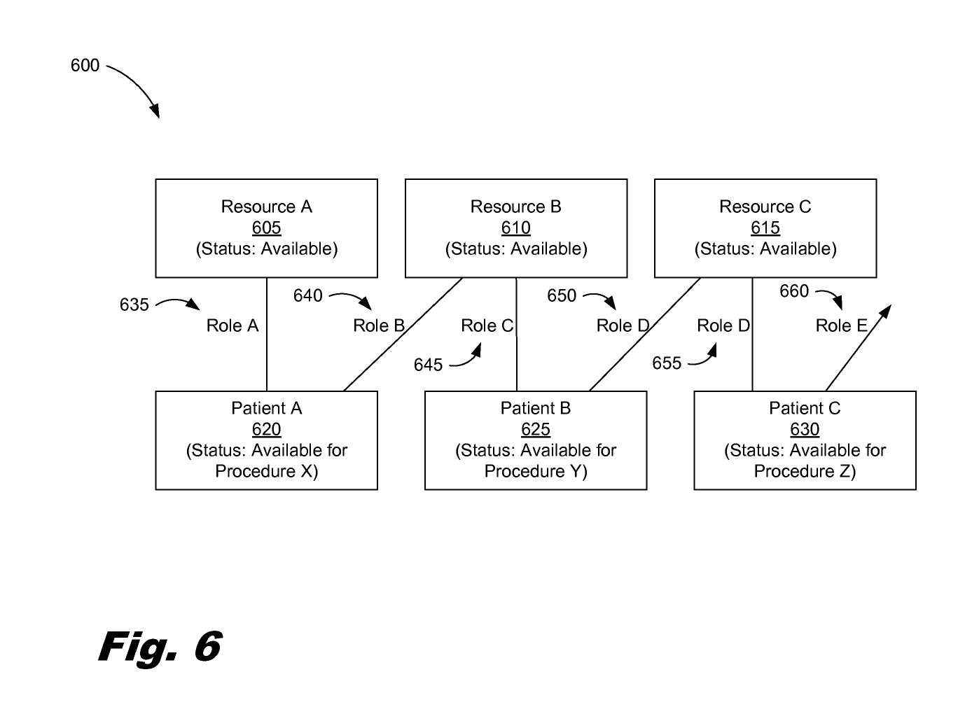

Turning now to FIG. 5, a flowchart describing a method (500) of building a dynamic simulation model according to one example of principles described herein is shown. The method may begin with a user defining (505) resources available in the environment. As discussed above the resources may include any person or object which exists or could exist in the environment which the system (100, 200) may use to provide services to a customer. The definition (505) of the resources may include additional information such as the type and abilities of any one resource.

The method may further include defining (510) a number of policies to be implemented on the system (100, 200). The policies guide the behavior of the system (100, 200) by determining which process being executed in the service environment has priority over the rest of the processes.

The method may continue with the system (100, 200) receiving (515) historical traces of monitoring data. As described above, the historical traces describe real or synthetically prepared processes that have or may occur in the environment. Using the data associated with the historical traces, policies, and resources, the system (100, 200) may create (520) a dynamic model of the environment. The dynamic model may represent the current services being provided, the resources that are or are not available for use, and any anticipated decisions that are to be made by a user of the system.

The present specification also describes a computer program product for building a dynamic simulation model. The computer program product may comprise a computer readable storage medium having computer usable program code embodied therewith. The computer usable program code may comprise computer usable program code to, when executed by a processor, define resources available in the environment. Additionally, the computer usable program code may comprise computer usable program code to, when executed by a processor, define a number of policies to be implemented on the system (100, 200). The computer usable program code may further comprise computer usable program code to, when executed by a processor, receive historical traces of monitoring data. Even further, the computer usable program code may comprise computer usable program code to, when executed by a processor, create a dynamic model of the environment.

The specification and figures describe a capacity planning system and a method of building a dynamic simulation model. This capacity planning system may have a number of advantages, including providing a capacity planning system that receives historical trace data and directly and dynamically creates the dynamic simulation model representing the state of the environment. Additionally, the system uses a driven input processor to map the historical traces onto a simulation model and allow administrators to control the generation of the dynamically evolving model to evaluate different planning issues.

The preceding description has been presented to illustrate and describe examples of the principles described. This description is not intended to be exhaustive or to limit these principles to any precise form disclosed. Many modifications and variations are possible in light of the above teaching.

What is claimed is:

1. A capacity planning system (100, 200), comprising:
a memory device (112, 212) storing a number of historical input data files (115, 215), a number of input data configuration files (120, 220), and a number of simulator configuration files (125, 225);
a processor (130, 230) communicatively coupled to the memory device (112, 212);
a decision policy module (110, 210) communicatively coupled to the processor (130, 230) that creates a number of decision policies based on an environment in which the system (100, 200) is operating and the historical input data files (115, 215); and
a simulator (135, 235) that executes the number of decision policies based on the data provided to it by the processor (130, 230) and provides a dynamically evolving model of an environment as a number of resources defined in the number of simulator configuration files (125, 225) move through the environment.

2. The system (100, 200) of claim 1, further comprising a monitoring model schema module (205) communicatively coupled to the processor (130, 230) that defines attributes of data that are input into the system (100, 200).

3. The system (100, 200) of claim 2, in which the monitoring model schema module (205) monitors the number of input data files (115, 215) and, based on the number of input data configuration files (120, 220), normalizes the input data files (115, 215) as defined by the input data configuration files (120, 220).

4. The system (100, 200) of claim 1, further comprising a visualization sub-system (245) communicatively coupled to the simulator (135, 235) that provides to a user a visual representation of the environment in real-time.

5. The system (100, 200) of claim 4, further comprising a simulation control module (250) communicatively coupled to the simulator (135, 235) that, in real time, allows a user to add to, delete, or change the number of decision policies executed on the simulator.

6. The system (100, 200) of claim 1, in which number of historical input data files (115, 215) describes historical monitoring data from the execution of real or synthetically prepared processes.

7. The system (100, 200) of claim 1, in which the processor (130, 230) maps the data provided by the number of input data files (115, 215), the number of input data configuration files (120, 220), and the number of simulator configuration files (125, 225) onto the simulator (135, 235) in a form addressable by the simulator (135, 235).

8. The system of claim 1, in which the simulator (135, 235) in executing the number of decision policies based on the data provide to it by the processor (130, 230) matches resources available in the environment with a resource request.

9. The system of claim 1, in which the system (100, 200) provides to a user, via the visualization sub-system (245), possible impacts on the performance of the system (100, 200) in response to changes to the mix or arrival rate of processes, resource levels, and decision making policies.

10. A method (500) of building a dynamically evolving model within a capacity planning system, comprising:
defining (505) resources available in an environment;
defining (510), with a decision policy module (110, 210), a number of policies to be implemented in the environment;
receiving (515) historical traces of monitoring data; and
with a processor (130, 230), creating (520) a dynamic model of the environment based on the historical traces of monitoring data.

11. The method (500) of claim 10, further comprising normalizing the historical traces (300) based on a number of input data configuration files (120, 220).

12. The method (500) of claim 10, further comprising providing a visual representation of the dynamic model of the environment in real-time.

13. The method (500) of claim 10, further comprising, in real time, receiving instructions to add, delete, or change the number of decision policies (140, 240) executed in the dynamic simulation model.

14. The method (500) of claim 10, in which creating (520) a dynamic model of the environment based on the historical traces of monitoring data further comprises matching resources available in the environment with a resource request.

15. A computer program product for building a dynamically evolving model, the computer program product comprising:
a computer readable storage medium (112, 212) having computer usable program code embodied therewith, the computer usable program code comprising:
computer usable program code to, when executed by a processor, define resources available in an environment;
computer usable program code to, when executed by a processor, define a number of policies to be implemented in the environment;
computer usable program code to, when executed by a processor, receive historical traces (300) of monitoring data;
computer usable program code to, when executed by a processor, create a dynamic model of the environment based on the historical traces (300).
